(19) United States
(12) Patent Application Publication
(10) Pub. No.: US 2021/0043374 A1
(43) Pub. Date: Feb. 11, 2021

(54) INSULATED WINDING WIRE TRANSFORMER FOR WELDING-TYPE POWER SUPPLIES

(71) Applicant: Illinois Tool Works Inc., Glenview, IL (US)

(72) Inventor: Dennis Roland Sigl, Greenville, WI (US)

(21) Appl. No.: 16/537,065

(22) Filed: Aug. 9, 2019

(51) Int. Cl. H01F 30/06; H01F 38/08; H01F 27/32; H01F 27/28

(52) U.S. Cl. CPC H01F 30/06; H01F 38/085; H01B 3/445; H01F 27/324; H01F 27/2823; H01F 27/323

(57) ABSTRACT

A high-frequency transformer for use in welding-type power supplies. The high-frequency transformer includes insulated winding wire which may allow for compressed turns. Compressed turns may result in lower leakage inductance and physically smaller transformers.

### BACKGROUND

The present disclosure relates to welding-type devices and, more particularly, to welding-type power supplies including a high-frequency transformer.

Welding is a process that has increasingly become ubiquitous. There are many different welding processes. Welding-type components (e.g., welding torches) are sometimes powered by welding-type power supplies. Conventional power supplies use a range of electrical components and/or electrical circuitry to produce appropriate welding-type power for various welding-type operations and/or welding-type components. Some welding-type power supplies use high-frequency transformers to condition incoming power so that it is usable for the particular welding-type application.

### SUMMARY

The present disclosure relates to high-frequency transformers including insulated winding wire, and, more particularly to welding-type power supplies including high-frequency transformers, substantially as illustrated by and described in connection with at least one of the figures, as set forth more completely in the claims.

### BRIEF DESCRIPTION OF THE DRAWINGS

FIG. 1 is an illustration of an example welding-type system in accordance with aspects of this disclosure.

FIG. 2 is a block diagram of an example welding-type power supply including a transformer.

FIG. 3 is a cross sectional view of a transformer having a horizontal winding arrangement.

FIG. 4 is a cross sectional view of a transformer having a sectionalized winding arrangement.

FIG. 5 is a cross sectional view of a transformer having a vertical winding arrangement.

FIG. 6a is an illustration of a type of litz wire that may be used in transformer windings.

FIG. 6b is an illustration of a type of flat litz wire that may be used in transformer windings

The figures are not necessarily to scale. Where appropriate, similar or identical reference numerals are used to refer to similar or identical elements.

### DETAILED DESCRIPTION

Welding-type systems often require a voltage step-down of the primary or input power for a particular welding, cutting, or heating application. Primary, or input power, is typically supplied to the welding, cutting, or heating system at voltages ranging from 110V to 1000V. However, the desired output voltage is typically lower. Generally, transformers, rectifiers, and/or filters are used to convert the input power to usable power for the welding-type application.

A transformer is typically used to reduce or increase the voltage of input power and/or intermediate power to output power that is usable for the particular welding, cutting, or heating application. Transformers are typically made up of primary and secondary windings, or coils, around a metal core. As such, the primary voltage, or input voltage, enters the primary winding and creates a magnetic field that induces voltage in the secondary winding. The secondary winding then yields a voltage that is usable for the welding, cutting, or heating application. Typically, a turns ratio determines the secondary voltage. For example, by dividing the number of turns and the primary winding by the number of turns in a secondary winding will determine the amount by which the input voltage is stepped down by the transformer. For example, a primary winding having 120 turns and operable at 240 volts may have a corresponding secondary winding having 12 turns that yield or output 24 volts. As such, the input voltage is stepped down by ten-fold.

High-frequency transformers are particularly applicable to inverter-controlled power supplies. High-frequency transformers may be rated to operate between 10 kHz and 500 kHz. In an example inverter-controlled power converter, the incoming power is first rectified to DC and then filtered for smoothness. The filtered DC power is then sent through one or more IGBTs that converts the DC power back to AC power, at a high frequency. This high frequency alternating current is then stepped down or stepped up by a transformer in a manner similar to that described above. A rectifier and filter then rectify the stepped down AC signal to a DC signal and filter the DC signal to produce output power appropriate to the application or load.

Leakage inductance in high-frequency transformers may negatively impact the performance of welding-type power supplies. For example, leakage inductance may reduce the output of the welding-type power supply, may lead to overheating of the primary and/or secondary coils, and/or may be detrimental to transistor switching circuits in the welding-type power supply. Reducing leakage inductance is therefore generally desirable.

Leakage inductance results from primary coil flux that does not link to the secondary coil. The amount of primary coil flux linked to the secondary coil is dependent on the physical orientation and location of the primary and secondary coils with respect to each other. Reducing or minimizing the mean distance between the turns of the primary coil and the turns of the secondary coil will typically reduce or minimize leakage inductance in a transformer. Reducing or minimizing the mean length of the turns in a coil will also typically reduce or minimize leakage inductance. By decreasing the distance between the windings, the leakage inductance, primary magnetizing current, machine losses, transformer cost, and transformer size may be decreased. The thermal impedance of the winding is decreased as the thermal path is shorter, and there are less contact thermal resistances. Thus, decreasing the distance between windings allows for the use of smaller conductors.

The International Electrotechnical Commission (“IEC”) 60974-1 standard requires a minimum distance through insulation for the transformer windings. Distance through insulation refers to the thickness of insulation between two separate conductors. The entirety of the IEC 60974-1 standard, fifth edition, published Jan. 11, 2019, is hereby incorporated by reference. Conventional high-frequency transformers insulate the winding wires (i.e., insulate the primary winding from the secondary winding) via interleaved insulation paper, film, or intermediate bobbins. Example high-frequency transformers that include bobbins are described in U.S. Pat. No. 6,611,189 to Dennis Sigl, filed May 22, 2001, titled “Welding Power Supply Transformer.” The entirety of U.S. Pat. No. 6,611,189 is incorporated by reference. Example high-frequency transformers that include bobbins are also described in U.S. Pat. No. 6,794,976 to Dennis Sigl, filed Dec. 24, 2002, titled “HF Transformer Assembly Having A Higher Leakage Inductance Boost Winding.” The entirety of U.S. Pat. No. 6,794,976 is incorporated by reference.

The present disclosure relates to high-frequency transformers for use in welding-type power supplies that include insulated winding wires to achieve reinforced insulation. Individual layers of insulative material, such as of fluorinated ethylene propylene (“FEP”), ethylene tetrafluoroethylene (“ETFE”), or perfluoroalkoxy (“PFA”), surround the winding wires to achieve the required distance through insulation (e.g., the distance through insulation required by the IEC 60974-1 standard). The insulative layers may be wrapped around or extruded onto the winding wire.

Insulating the winding wires of welding-type high-frequency transformers allows for compliance with the distance through insulation requirements of the IEC 60974-1 standard without intermediate bobbins, interleaved insulation paper, or film. Using insulated winding wire also allows the distance between the windings to be decreased as compared to a transformer which uses intermediate bobbins to achieve the required distance through insulation. Decreasing the distance between windings also decreases leakage inductance, primary magnetizing current, machine losses, transformer cost, and transformer size. Decreasing the distance between the windings also decreases the thermal impedance of the windings since the thermal path is shorter and therefore there are less contact thermal resistances as well. Decreasing the distance between windings thus allows for the use of smaller conductors.

Disclosed example high-frequency transformers for producing welding-type output power include: a magnetic core; a first conductive coil wrapped around the magnetic core, the first conductive coil including a first conductive layer and at least one insulative layer extruded onto the conductive layer; and a second conductive coil wrapped around the magnetic core, the second conductive coil including a second conductive layer, and, a number of insulative layers extruded onto the first conductive layer and a number of insulative layers extruded onto the second conductive layer totals at least three insulative layers, and a total thickness of the insulative layers extruded onto the first conductive layer and the second conductive layer is at least 0.35 millimeters.

In some example high-frequency transformers, the first conductive layer and the second conductive layer include one of stranded wire or litz wire.

In some example high-frequency transformers, the first coil includes three insulative layers.

In some example high-frequency transformers, the first coil includes two insulative layers and the second coil includes at least one insulative layer.

In some example high-frequency transformers, the insulative layers includes one of fluorinated ethylene propylene, ethylene tetrafluoroethylene, or perfluoroalkoxy.

In some example high-frequency transformers, each insulative layer is at least 0.0875 millimeters thick.

In some example high-frequency transformers, the second coil includes an enamel layer around the second conductive layer.

In some example high-frequency transformers, the first coil has a radius greater than the radius of the second coil, and the second coil is arranged inside the circumference of the first coil.

In some example high-frequency transformers, the first coil and the second coil have a sectionalized arrangement.

In some example high-frequency transformers, the first coil and the second coil have a vertical arrangement.

In some example high-frequency transformers, the high-frequency transformer has a rated supply voltage of up to 1000 volts.

In some example high-frequency transformers, the high-frequency transformer is operable between 10 kilohertz and 500 kilohertz.

In some example high-frequency transformers, the first conductive coil and the second conductive coil comply with IEC 61558-1, Annex K.

Some disclosed example high-frequency transformers include a third conductive coil wrapped around the magnetic core, the third conductive coil included a third conductive layer, and: a number of insulative layers extruded onto the first conductive layer and a number of insulative layers extruded onto the third conductive layer totals at least three insulative layers; and a number of insulative layers extruded onto the second conductive layer and a number of insulative layers extruded onto the third conductive layer totals at least three insulative layers.

Disclosed example welding-type power supplies include: power conversion circuitry configured to convert input power to welding-type power, the power conversion circuitry includes: a high-frequency transformer including: a magnetic core; a first conductive coil wrapped around the magnetic core, the first conductive coil including a first conductive layer and at least one insulative layer extruded onto the conductive layer; and a second conductive coil wrapped around the magnetic core, the second conductive coil including a second conductive layer, and, a number of insulative layers extruded onto the first conductive and a number of insulative layers extruded onto the second conductive layer is at least three insulative layers, and a total thickness of the insulative layers extruded around the first conductive layer and the second conductive layer is at least 0.35 millimeters.

In some disclosed example welding-type power supplies, the first conductive layer and the second conductive layer comprise one of stranded wire or litz wire.

In some disclosed example welding-type power supplies, the first coil includes three insulative layers.

In some disclosed example welding-type power supplies, the first coil includes two insulative layers and the second coil includes at least one insulative layer.

In some disclosed example welding-type power supplies, the insulative layers include one of fluorinated ethylene propylene, ethylene tetrafluoroethylene, or perfluoroalkoxy.

As used herein, the terms “welding-type power supply,” “welding-type power source,” and “welding-type system,” refers to any device capable of, when power is applied thereto, supplying welding, cladding, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding).

As used herein, the term welding-type output means an output signal that is suitable for welding, plasma cutting or induction heating.

As used herein, the term “torch” or “welding-type tool” can include a hand-held or robotic welding torch, gun, or other device used to create the welding arc.

As used herein, the term “welding mode” is the type of process or output used, such as CC, CV, pulse, MIG, TIG, spray, short circuit, etc.

Welding operation, as used herein, includes both actual welds (e.g., resulting in joining, such as welding or brazing) of two or more physical objects, an overlaying, texturing, and/or heat-treating of a physical object, and/or a cut of a physical object) and simulated or virtual welds (e.g., a visualization of a weld without a physical weld occurring).

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy. Electric power of the kind measured in watts as the product of voltage and current (e.g., V*I power) is referred to herein as “wattage.”

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

The terms “control circuit” and “control circuitry,” as used herein, may include digital and/or analog circuitry, discrete and/or integrated circuitry, microprocessors, digital signal processors (DSPs), and/or other logic circuitry, and/or associated software, hardware, and/or firmware. Control circuits may include memory and a processor to execute instructions stored in memory. Control circuits or control circuitry may be located on one or more circuit boards, that form part or all of a controller, and are used to control a welding process, a device such as a power source or wire feeder, motion, automation, monitoring, air filtration, displays, and/or any other type of welding-related system.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

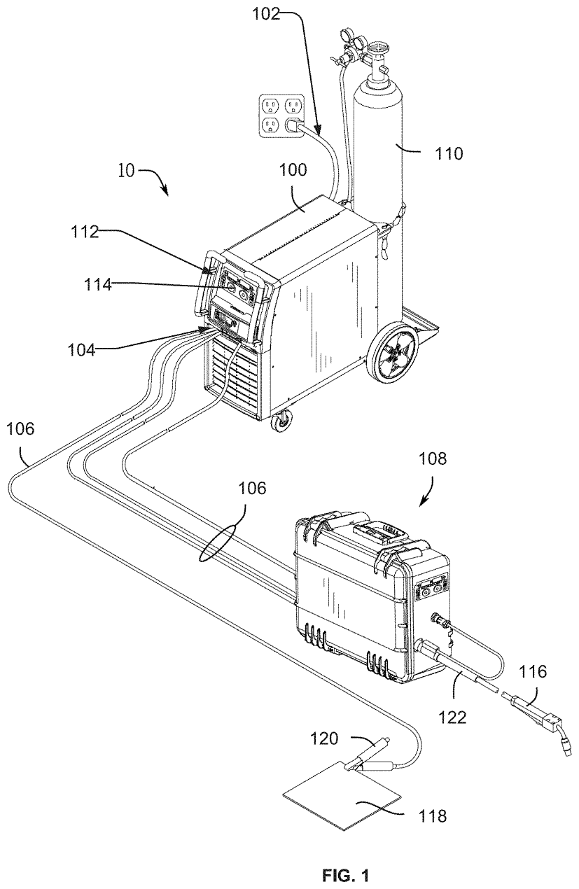

FIG. 1 illustrates an example welding type system 10 including a welding-type power supply 100. A source of power is provided to the welding-type power supply 100 via an AC power cord 102. Typical ranges of AC power may be 115/230 VAC or 208-600 VAC, and may include single-phase or three-phase power. The welding-type power supply 100 generally supplies power for the welding-type system 10. Weld output 104 provides welding output power via one or more weld cables 106 coupled to a welding torch 116 and a workpiece 118 using a clamp 120. The welding-type power supply 100 includes a high-frequency transformer which is used to reduce or increase the voltage of incoming power so that it is usable for the particular welding-type application. The high-frequency transformer includes a primary and a secondary winding, or coil, around a metal core. Primary voltage, or input voltage enters the primary winding and creates a magnetic field that induces output voltage that is usable for the welding-type application.

Welding-type output power provided by the welding-type power supply 100 may be in the range of 10 Amps to 600 amps or more, and range from substantially 0 volts in a short circuit condition to 44 volts or more into an open welding arc. Modern welding-type power supplies and systems can provide welding-type power for various welding-type processes which may include advanced waveform generation and control that is responsive to dynamic or static conditions at the welding arc.

The illustrated welding type system includes a wire feeder 108 and a gas supply 110. The welding power supply 100 may provide power and control to other equipment such as a wire feeder 108. In the illustrated example, the welding torch 116 is coupled to the wire feeder 108 via coupler 122 in order to supply welding wire, shielding gas from the gas supply 110, and/or welding-type power to the welding torch 116 during operation of the welding-type system 10. In some examples, the welding power source 100 may couple and/or directly supply welding-type power to the welding torch 116. The wire feeder 108 may require a certain type of power, for example, 24V or 50V for proper operation of the wire feeder 108 control circuits. The power for the wire feeder 108 may be provided by the welding power source 100 by a wire feeder 108 power supply circuit, or another type power circuit. In addition to power for the wire feeder 108, one or more control signals may also be provided to allow proper operation of the wire feeder 108 and welding power source 100. These control signals may be analog or digital and may provide control and communication in a bi-directional manner. The power and control signals may be provided to the wire feeder 108 from the welding power source via cable(s) 106.

The illustrated welding power source 100 has a control panel 112 with various types of control features 112, such as digital displays, control dials or potentiometers, control switches, LED indicators, etc. These control features 112 provide for normal operation and control of the welding system.

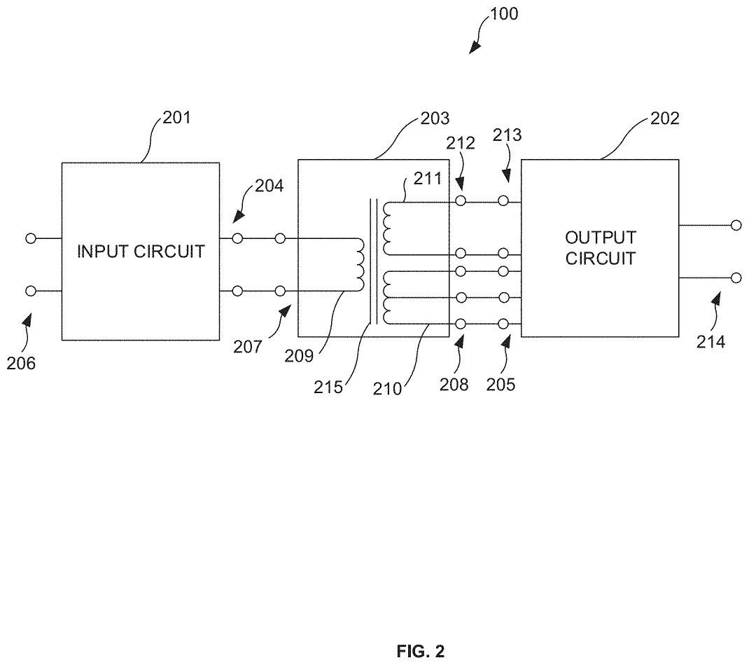

FIG. 2 shows a block diagram of an example welding-type power supply 100. The power supply 100 includes an input circuit 201, an output circuit 202 and a high-frequency transformer 203. The transformer 203 includes a magnetic core 215 (e.g., a ferrite core). The core 215 may be selected to lower leakage inductance, for example based on the amount of turns used. The transformer 203 is connected between an output 204 of input circuit 201 and inputs 205 and 213 of the output circuit 202. The input circuit 201 is configured to receive an input signal from an external source of power at the input 206. Input signal and output signal as used herein include voltage signals, current signals and power signals. The input circuit 201 includes any circuit capable of receiving an input signal from a source of power and providing an output signal usable by a transformer. Input circuits can include as part of their circuitry, microprocessors, analog and digital controllers, switches, other transformers, rectifiers, inverters, converters, choppers, comparators, phased controlled devices, buses, pre-regulators, diodes, inductors, capacitors, or resistors. The output circuit 202 includes any circuit capable of receiving an input signal from a transformer and providing an output signal suitable for a desired purpose, such as welding-type output signal. Output circuits can include microprocessors, analog and digital controllers, switches, other transformers, rectifiers, inverters, converters, choppers, comparators, phased controlled devices, buses, pre-regulators, diodes, inductors, capacitors, or resistors.

The input signal received at the input 206 is processed by the various circuitry of the input circuit 201 and the processed signal is provided to the transformer 203 via the output 204. The output signal from the input circuit 201 is received by the transformer 303 via the input 207 and transformed to the outputs 208, 212. The transformer 203 includes a primary coil 209 connected to the output 204 of input circuit 201 and a center tapped secondary coil 110 connected to the input 205 of output circuit 202. The secondary coil 210 is magnetically coupled with the primary coil 209. The primary coil 209 and the secondary coil 210 may have one or more insulative layers, for example, of FEP, ETFE, or PFA. The total distance through insulation of the primary coil 209 and the secondary coil 210 may comply with, for example, the IEC 60974-1 standard. For example, for a root mean square (“RMS”) rated supply voltage of up to 440 V, the distance through insulation is at least 0.35 millimeters (“mm”) where there are at least three layers of insulation between the primary coil 209 and the secondary coil 210. For an RMS rated supply voltage between 441 V and 690 V, the distance through insulation is at least 0.4 mm where there are at least three layers of insulation between the primary coil 209 and the secondary coil 210. For an RMS rated supply voltage between 691 V and 1000 V, the distance through insulation is at least 0.5 mm where there are at least three layers of insulation between the primary coil 209 and the secondary coil 210.

As illustrated, the power supply 100 also includes a boost coil 211 magnetically coupled with the primary coil 209. Boost coils may be used, for example, to maintain a welding arc during stick welding. The output 212 of the boost coil 212 is provided to the output circuit 202 via the input 213. The boost coil 211 may also include insulative layers, for example of FEP, ETFE, or PFA. The insulation of the boost coil 211 may comply with, for example, the IEC 60974-1 standard. However, the total distance through insulation may be modified to comply with different and/or additional standards.

In some examples, the secondary coil 210 of the transformer is not a tapped coil. In some examples, the secondary coil 210 is tapped at different locations such as quarter tapped or two-thirds tapped. In some examples, multiple secondary coils are provided such as two, three or four secondary coils, some or all of which may be connected to the output circuit 202.

The output signal from the secondary coil 210 is received by the output circuit 202 at input 105. The input signal is processed by the various circuitry of output circuit 102 and the processed signal is provided at the output 214 as a signal suitable for a welding-type application.

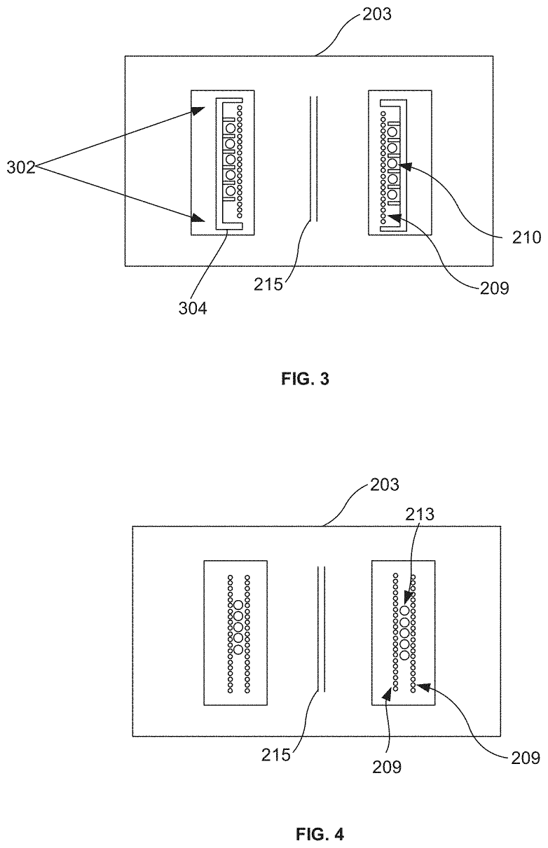

FIG. 3 illustrates a cross sectional view of a high-frequency transformer without an intermediate bobbin, for example the high-frequency transformer 203 of FIG. 2. In the illustrated example, the primary winding 209 has 20 turns, and the secondary winding 210 has 5 turns. The windings 209 and 210 are arranged in a horizontal fashion. In other words, the secondary winding 210 has a diameter that is greater than the diameter of the primary winding 209, and the secondary winding 210 is arranged around, or surrounding the primary winding 209, in order to minimize leakage inductance. Other numbers of turns, other turn ratios, and/or other inter-turn and/or inter-winding spacing may be used.

An example Underwriter's Laboratories approved insulation system for magnetic devices is NE-F1, which is manufactured by New England Wire Technologies Corp. For filament wires within the NE-F1 insulation system, additional ground and interwinding insulation is not required to separate an insulated wire from other windings or between this winding and grounded metal for UL approval. Accordingly, an additional advantage of insulating the winding wire (e.g., a filament wire) is that additional ground and interwinding insulation is not necessary to satisfy UL requirements if insulated winding wire is used.

Distance through insulation (“DTI”) refers to the total thickness of insulation, in one or more layers, between two separate conductors, such as the primary winding 209 and the secondary winding 210. For purposes of the IEC 60974-1 standard, conventional intermediate bobbins are considered to be a single layer of insulation, and therefore require at least 1.3 mm DTI for RMS supply voltages of up to 440 V. In contrast, the example primary winding 209 and the secondary winding 210 are constructed to have three total separate layers of insulation, individually formed around (e.g., wrapped, extruded, etc.) the windings 209, 210. In other words, the number of layers of insulation extruded onto the primary winding 209 plus the number of layers of insulation extruded onto the secondary winding 210 is at least three layers. The total DTI between the primary winding 209 and the secondary winding 210 in the example of FIG. 2 is at least 0.35 mm for RMS supply voltages of up to 440 V. Similarly, the primary winding 209 and the secondary winding 210 are constructed to have a DTI of at least is 0.4 mm distributed among at least three insulation layers for RMS supply voltages of 441 V to 690 V, and are constructed to have a DTI of at least is 0.5 mm distributed among at least three insulation layers for RMS rated supply voltages of 691 V to 1000 V. In contrast, a conventional intermediate bobbin has a DTI of at least 1.5 mm for RMS supply voltages of 441 V to 690 V and 2.0 mm for RMS rated supply voltages of 691 V to 1000 V.

Because the primary winding 209 and the secondary winding 210 use extruded insulative layers instead of bobbins, the DTI is smaller than conventional transformers that use intermediate bobbins, which enables more compact winding of the primary winding 209 and the secondary winding 210. In some examples, the transformer 203 complies with the IEC 61558-1 standard. The entirety of the IEC 61558-1 standard, third edition, published Sep. 29, 2017, is hereby incorporated by reference.

In some examples, the primary winding 209 may include three or more insulative layers, and the secondary winding 210 may have zero insulative layers. For multilayer insulation, the IEC 60974-1 standard recites that the total number of insulative layers is at least three separate layers extruded onto the winding wires. Thus, in examples where the primary winding 209 includes three or more insulative layers, the transformer 203 may comply with the IEC 60974-1 standard.

In some examples, the secondary winding 210 may include three or more insulative layers, and the primary winding 209 may have zero insulative layers. In examples where either the secondary winding 210 or the primary winding 209 have zero insulative layers, the winding with zero insulative layers (i.e., layers of Teflon® type insulation, including FEP, ETFE, or PFA insulation) may include an enamel layer which insulates the winding turn to turn.

In some examples, the primary winding 209 may have two or more insulative layers, and the secondary winding 210 has one insulative layer. In some examples, the secondary winding 210 may have two or more insulative layers, and the primary winding 209 has one insulative layer. In some examples, both the primary winding 209 and the secondary winding 210 have two insulative layers.

If the RMS rated supply voltage is 441 to 690 V and there are three total insulative layers, then each extruded insulative layer is at least 0.4/3 mm thick. Similarly, if the RMS rated supply voltage is up to 440 V then to, and if there are three total insulative layers, then each extruded insulative layer is at least 0.35/3 mm thick. In some examples, the windings 209 and 210 comply with the IEC 60974-1 standard.

In some examples, additional windings are included in the transformer 203, for example the boost winding 211. When additional windings are included in the transformer 203, the total number of insulative layers between any two windings is at least three separate insulative layers. The DTI between any the primary winding 209, the secondary winding 210, and the boost winding 211 is: 0.35 mm for RMS rated supply voltages up to 440 V; 0.4 mm for RMS rates supply voltages between 441 V and 690 V; and 0.5 mm for RMS rated supply voltages between 691 V and 1000 V. In some examples, the number of insulative layers on each winding (209, 210, and 211) is at least two such that the total number of insulative layers between any two windings will exceed three layers. In some examples, each insulative layer is at least 0.0875 mm thick.

As shown, the primary coil 209 and the secondary coil 210 are wound with two sections in a horizontal manner to manage the lead exits, keep the coil internal thermal conduction resistance to a minimum, and to minimize the number of leads to prepare. The secondary turns 210 do not fill the window 302, which dictates that the secondary winding 210 should be placed around (i.e., outside of) the primary winding 209. A total number of extruded insulative layers of the primary winding 209 and the secondary winding 210 is at least three layers. The insulative layers also insulate the windings 209 and/or 210 from the metal core 215, which may obviate a need for a coil cover 304. In some examples, a coil cover 304 may be included to facilitate lead anchoring and winding spacing. For example, a coil cover 304 may compress the windings 209 and/or 210 to lower thermal contact resistance. With extruded insulation as described, a coil cover 304 may be omitted, which may reduce the total cost of the transformer 203 and increase the usable area of the window 302.

FIG. 4 illustrates a transformer 400 which includes three winding sections as one winding (e.g., the primary winding 209) is split into two parts. Leakage inductance may be reduced by splitting one of the windings (e.g., the primary winding 209) into two sections. This type of winding arrangement may require more complexity and/or cost as compared to the horizontal winding arrangement of FIG. 3. For example, splitting a winding may require more winding leads. In some examples, both the primary and the secondary windings may be split (e.g., there may be four or more winding sections.) In some examples, at least one of the windings 209 or 210 may be split into more than two sections. In some examples, the windings may be sectionalized in a vertical arrangement.

Alternatively to reduce leakage inductance, the number of turns may be reduced and two winding sections may be used (as shown in FIG. 3). The core cross section is independent of the number of winding sections.

In some examples, the primary winding 209 and the secondary winding 210 may be wound bi-filar. In a bi-filar arrangement, the wires of the primary winding 209 and the secondary winding 210 are wound side-by-side. A larger diameter winding wire may be split into smaller wires in parallel. A bi-filar arrangement may provide a lower leakage inductance, but also may increase the complexity of winding lead exits.

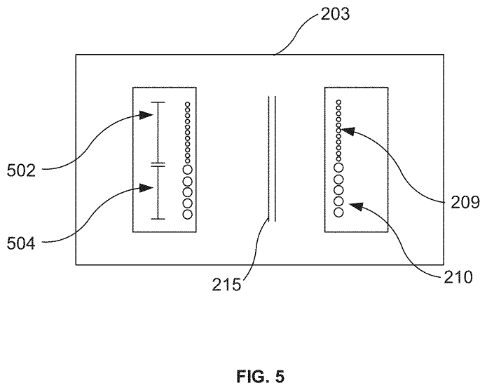

In some examples, as shown in FIG. 5, the windings 209 and 210 may be arranged in vertical sections 502 and 504. A vertical arrangement may include wedges on the sides of the wire to compress the sections of wire against each other to achieve low leakage inductance.

Conventional high-frequency transformers that use a vertical arrangement typically include a molded-in barrier in the bobbin having a thickness of greater than 1.5 mm. This vertical section barrier obviates the need to have insulation extruded onto the wire, but results in a higher leakage inductance as well as a requirement to manage the winding lead exits. A vertical arrangement without extruded insulation may also require a coil cover to insulate the wire winding from the metal core. If insulated winding wire is used, as described in the present disclosure, a bobbin and the corresponding molded-in barrier may be omitted.

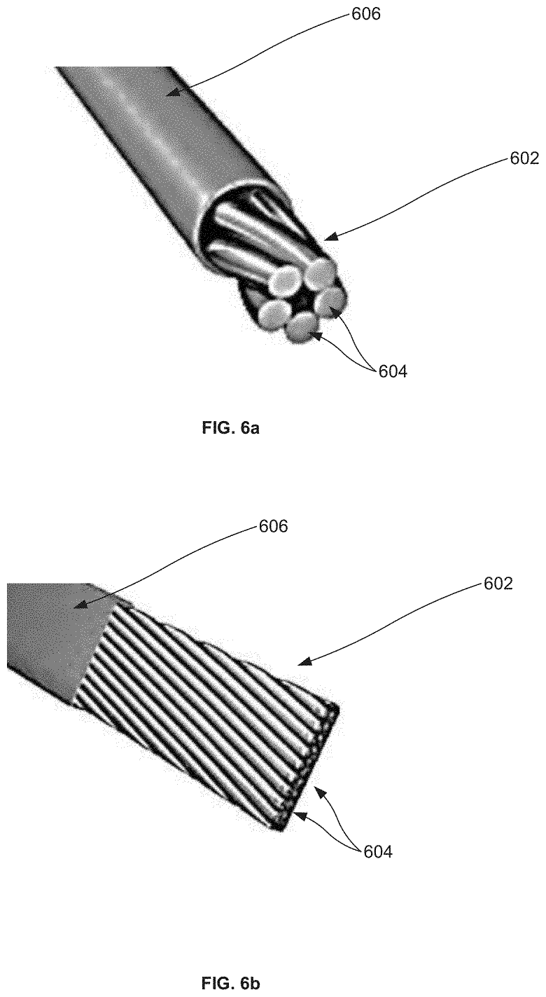

As shown in FIGS. 6a and 6b, each of the primary and secondary windings (209 and 210 of FIG. 2) may be a conductor 602 made of stranded or bunched wire, meaning that each winding coil may include multiple wires 604. In some examples, each individual wire 604 within the conductor include an enamel covering. In some examples, as shown in FIG. 6a, the primary and secondary windings are Litz wires (i.e., stranded wires that are twisted or braided, and which may be individually insulated). In other words, the Litz wires generally reduce AC losses in high frequency windings. In some examples, as shown in FIG. 6b, one or more of the windings 209 and 210 may be generally flat or rectangular. In some examples, the strands 604 of wire that make up a winding are not twisted and are bunched together and placed in parallel.

In accordance with the present disclosure, insulative layers 606 may be place around the conductor 602 (e.g., extruded onto the conductor 604), where the conductor 602 may include multiple wires 604. In some examples, the insulative layers 606 may comply with the IEC 60974-1 standard.

The present methods and/or systems may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A high-frequency transformer for producing welding-type output power, the high frequency transformer comprising:
a magnetic core;
a first conductive coil wrapped around the magnetic core, the first conductive coil comprising a first conductive layer and at least one insulative layer extruded onto the conductive layer; and
a second conductive coil wrapped around the magnetic core, the second conductive coil comprising a second conductive layer, and, wherein a number of insulative layers extruded onto the first conductive layer and a number of insulative layers extruded onto the second conductive layer totals at least three insulative layers, and a total thickness of the insulative layers extruded onto the first conductive layer and the second conductive layer is at least 0.35 millimeters.

2. The high-frequency transformer of claim 1, wherein the first conductive layer and the second conductive layer comprise one of stranded wire or litz wire.

3. The high-frequency transformer of claim 1, wherein the first coil includes three insulative layers.

4. The high-frequency transformer of claim 1, wherein the first coil includes two insulative layers and the second coil includes at least one insulative layer.

5. The high-frequency transformer of claim 1, wherein the insulative layers comprise one of fluorinated ethylene propylene, ethylene tetrafluoroethylene, or perfluoroalkoxy.

6. The high-frequency transformer of claim 1, wherein each insulative layer is at least 0.0875 millimeters thick.

7. The high-frequency transformer of claim 1, wherein the second coil comprises an enamel layer around the second conductive layer.

8. The high-frequency transformer of claim 1, wherein the first coil has a radius greater than the radius of the second coil, and wherein the second coil is arranged inside the circumference of the first coil.

9. The high-frequency transformer of claim 1, wherein the first coil and the second coil have a sectionalized arrangement.

10. The high-frequency transformer of claim 1, wherein the first coil and the second coil have a vertical arrangement.

11. The high-frequency transformer of claim 1, wherein the high-frequency transformer has a rated supply voltage of up to 1000 volts.

12. The high-frequency transformer of claim 1, wherein the high-frequency transformer is operable between 10 kilohertz and 500 kilohertz.

13. The high-frequency transformer of claim 1, wherein the first conductive coil and the second conductive coil are not separated by a bobbin.

14. The high-frequency transformer of claim 1, wherein the first conductive coil and the second conductive coil comply with IEC 61558-1, Annex K.

15. The high-frequency transformer of claim 1, comprising a third conductive coil wrapped around the magnetic core, the third conductive coil comprising a third conductive layer, and wherein:
a number of insulative layers extruded onto the first conductive layer and a number of insulative layers extruded onto the third conductive layer totals at least three insulative layers; and
a number of insulative layers extruded onto the second conductive layer and a number of insulative layers extruded onto the third conductive layer totals at least three insulative layers.

16. A welding-type power supply comprising:
power conversion circuitry configured to convert input power to welding-type power, the power conversion circuitry comprising:
a high-frequency transformer including:
a magnetic core;
a first conductive coil wrapped around the magnetic core, the first conductive coil comprising a first conductive layer and at least one insulative layer extruded onto the conductive layer; and
a second conductive coil wrapped around the magnetic core, the second conductive coil comprising a second conductive layer, and, wherein a number of insulative layers extruded onto the first conductive and a number of insulative layers extruded onto the second conductive layer is at least three insulative layers, and a total thickness of the insulative layers extruded around the first conductive layer and the second conductive layer is at least 0.35 millimeters.

17. The welding-type power supply of claim 16, wherein the first conductive layer and the second conductive layer comprise one of stranded wire or litz wire.

18. The welding-type power supply of claim 16, wherein the first coil includes three insulative layers.

19. The welding-type power supply of claim 16, wherein the first coil includes two insulative layers and the second coil includes at least one insulative layer.

20. The welding-type power supply of claim 16, wherein the insulative layers comprise one of fluorinated ethylene propylene, ethylene tetrafluoroethylene, or perfluoroalkoxy.
